(19) United States
(12) Patent Application Publication
(10) Pub. No.: US 2024/0053439 A1
(43) Pub. Date: Feb. 15, 2024

(54) TIME-OF-FLIGHT MODULES

(71) Applicant: Sony Semiconductor Solutions Corporation, Atsugi-shi, Kanagawa (JP)

(72) Inventors: Nicolangelo LOPEZ, Stuttgart (DE); Luc BOSSUYT, Stuttgart (DE); Camille GIAUX, Stuttgart (DE); Victor BELOKONSKIY, Stuttgart (DE)

(73) Assignee: Sony Semiconductor Solutions Corporation, Atsugi-shi, Kanagawa (JP)

(21) Appl. No.: 18/269,288

(22) PCT Filed: Nov. 11, 2021
(86) PCT No.: PCT/EP2021/081342

§ 371 Date: Jun. 23, 2023

(30) Foreign Application Priority Data
Dec. 30, 2020 (EP) 20217819.0

(51) Int. Cl. G01S 7/48; G01S 7/481; G01S 17/894

(52) U.S. Cl. CPC G01S 7/4808; G01S 7/4815; G01S 17/894

(57) ABSTRACT

A time-of-flight module with switchable illumination for a scene, including: a time-of-flight sensor configured to generate time-of-flight data representing a time-of-flight measurement of light reflected from the scene; a full-field illuminator configured to provide a full-field illumination to the scene; a spot illuminator configured to provide a spotted illumination to the scene; and a control unit configured to switch between the full-field illumination and the spotted illumination provided to the scene; wherein the full-field illuminator and the spot illuminator are arranged adjacent to the time-of-flight sensor.

### TECHNICAL FIELD

The present disclosure generally pertains to time-of-flight modules with switchable illumination for a scene.

### TECHNICAL BACKGROUND

Generally, time-of-flight (ToF) systems are known, which are used for determining a distance to objects in a scene or a depth map of (the objects in) the scene that is illuminated with light.

Basically, two different techniques for the distance measurement are known: direct ToF (“dToF”) and indirect ToF (“iToF”). In dToF systems, the distance is determined based on a time-of-arrival of a light pulse reflected at objects in the scene. In iToF systems, the scene is illuminated with a modulated light wave and a phase difference between emitted and reflected light wave is indicative for the distance.

Moreover, two different types of illumination are known: frill-field illumination and spotted illumination. With full-field illumination, the scene is illuminated with a continuous spatial light profile. For example, a light beam which has a high-intensity area in the center of the light beam with a continuously decreasing light intensity away from the center of the light beam. With spotted illumination, the scene is illuminated with a plurality of light spots.

Although there exist techniques for time-of-flight systems, it is generally desirable to improve the existing techniques.

### SUMMARY

According to a first aspect the disclosure provides a time-of-flight module with switchable illumination for a scene, comprising:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene; and
a control unit configured to switch between the full-field illumination and the spotted illumination provided to the scene;
wherein the full-field illuminator and the spot illuminator are arranged adjacent to the time-of-flight sensor.

According to a second aspect the disclosure provides a time-of-flight module with switchable illumination for a scene, comprising:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene;
a control unit configured to switch between the full-field illumination and the spotted illumination provided to the scene; and
an image sensor configured to generate image data representing an image of the scene;
wherein the time-of-flight sensor, the full-field illuminator, the spot illuminator and the image sensor are arranged in a line, wherein the time-of-flight sensor and the image sensor are arranged adjacent to each other.

According to a third aspect the disclosure provides a time-of-flight module with switchable illumination for a scene, comprising:
a time-of-flight sensor configured to generate time-of-flight data representing a time-of-flight measurement of light reflected from the scene; and
a switchable illuminator configured to provide either a full-field illumination or a spotted illumination to the scene based on an illumination switch command obtained from a control unit; wherein
the control unit is configured to transmit the illumination switch command to the switchable illuminator for switching between the frill-field illumination and the spotted illumination provided to the scene; and
the switchable illuminator is arranged adjacent to the time-of-flight sensor.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a block diagram an embodiment of an iToF system with a full-field illuminator;

FIG. 2 schematically illustrates in a block diagram an embodiment of an iToF system with a spot illuminator;

FIG. 3 schematically illustrates in a block diagram in FIG. 3A a first embodiment of a light source driver and in FIG. 3B a second embodiment of a light source driver;

FIG. 4 schematically illustrates in a block diagram in FIG. 4A a first embodiment of a time-of-flight module, and in FIG. 4B a top view corresponding to the first embodiment of the time-of-flight module;

FIG. 5 schematically illustrates in a block diagram in FIG. 5A a top view of a second embodiment of a time-of-flight module, in FIG. 5B a top view of a third embodiment of a time-of-flight module, and in FIG. 5C a top view of a fourth embodiment of a time-of-flight module;

FIG. 6 schematically illustrates in a block diagram in FIG. 6A a top view of a fifth embodiment of a time-of-flight module, in FIG. 6B a top view of a sixth embodiment of a time-of-flight module, in FIG. 6C a top view of a seventh embodiment of a time-of-flight module, and in FIG. 6D a top view of a eight embodiment of a time-of-flight module;

FIG. 7 schematically illustrates in a block diagram in FIG. 7A a nineth embodiment of a time-of-flight module, and in FIG. 7B a top view corresponding to the nineth embodiment of the time-of-flight module; and

FIG. 8 schematically illustrates in a block diagram in FIG. 8A a top view of a tenth embodiment of a time-of-flight module, in FIG. 8B a top view of an eleventh embodiment of a time-of-flight module, and in FIG. 8C a top view of a twelfth embodiment of a time-of-flight module.

### DETAILED DESCRIPTION OF EMBODIMENTS

Before a detailed description of the embodiments under reference of FIG. 4 is given, general explanations are made.

As mentioned in the outset, basically, two different time-of-flight (ToF) distance measurement techniques are known, which are used in some embodiments: direct ToF (“dToF”) and indirect ToF (“iToF”).

In dToF systems, in some embodiments, the distance is determined based on a time-of-arrival of a light pulse emitted by an illuminator towards a scene where the light pulse is at least partially reflected at objects in the scene. A time between two consecutive light pulses is typically divided into time intervals with equal spacing. In such embodiments, time-of-flight data (ToF data) is generated by a time-of-flight sensor (“ToF sensor”) in the form of a histogram for each pixel of the ToF sensor. The histogram represents a number of events (e.g. detected photons) arrived in a particular time interval. This process may be repeated several times to increase a signal-to-noise ratio.

In iToF systems, in some embodiments, the scene is illuminated with a modulated light wave and a phase difference between emitted and reflected light wave is determined which is indicative for the distance. In some embodiments, ToF data is generated by a ToF sensor corresponding to four frames with different phase shifts (e.g. 0°, 90°, 180° and 270°) between a light modulation signal applied to an illuminator and a demodulation signal applied to the ToF sensor. In such embodiments, the ToF data includes pixel values of a plurality of pixels of the ToF sensor of the four frames. Based on the captured four frames, component data (IQ values: Q is quadrature component, I is in-phase component) may be calculated. In some embodiments, ToF data includes component data.

Moreover, as also mentioned in the outset, basically, two different types of illuminators with different illumination profiles are known, which are used in some embodiments: full-field illuminators and spot illuminators.

The full-field illuminator, in some embodiments, provides a full-field illumination to a scene such that the scene is illuminated with a continuous spatial light profile. For example, a light beam which has a high-intensity area in the center of the light beam with a continuously decreasing light intensity away from the center of the light beam.

The spot illuminator, in some embodiments, provides a spotted illumination to a scene such that the scene is illuminated with a plurality of light spots. In other words, the scene is illuminated with a light pattern of (separated) high-intensity and low-intensity (or substantially zero-intensity) areas such as, for example, a pattern of light spots (e.g. light dots). In some embodiments, the spot illuminator provides a spatially modulated light field-of-illumination (light pattern) with vertical or horizontal stripes or with a checker pattern. Generally, in some embodiments, the spot illuminator provides a spatially modulated field-of-illumination (light pattern) to a scene where a light intensity is low (or substantially zero) in part of the light pattern.

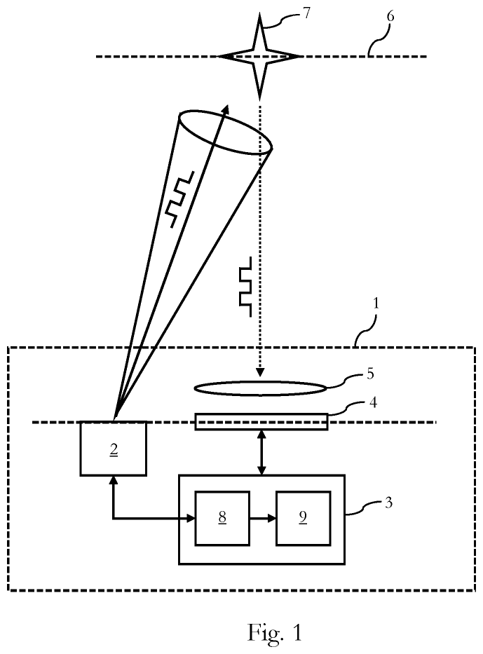

For enhancing the general understanding of the present disclosure, an embodiment of an iToF system 1 with a full-field illuminator 2 is discussed under reference of FIG. 1, there the embodiment of the iToF system 1 is schematically illustrated in a block diagram.

The iToF system 1 is a frill-field iToF system for depth sensing or providing a distance measurement. The iToF system 1 includes a full-field illuminator 2, a control unit 3, a ToF sensor 4 and an optical lens portion 5.

The full-field illuminator 2 provides a full-field illumination to a scene 6 and emits intensity-modulated light (in time) to the scene 6 including an object 7, which reflects at least part of the (full-field illumination) light. The reflected light from the object 7 is imaged by the optical lens portion 5 onto the ToF sensor 4.

The control unit 3 controls the overall operation of the ToF system 1 and includes an image processing unit 8 and a 3D image reconstruction unit 9.

The control unit 3 controls the light emission timing of the full-field illuminator 2 based on a modulation signal (which may be e.g. a rectangular modulation signal having a modulation period 1) applied to the full-field illuminator 2. The control unit 3 applies a demodulation signal to the ToF sensor 4 which corresponds to the modulation signal applied to full-field illuminator 2. The control unit 3 applies four demodulation signals to the ToF sensor 4 corresponding to four phase shifts (0°, 90°, 180° and 270°) between the modulation signal and the demodulation signal for capturing four frames.

The ToF sensor 4 generates ToF data corresponding to the four frames including pixel values of a plurality of pixels generated in accordance with an amount of reflected light imaged by the optical lens portion 5 onto each of the pixels and in accordance with the demodulation signal.

The image processing unit 8 obtains the ToF data from the ToF sensor 4. The image processing unit 8 determines, based on the obtained ToF data, a phase-shift of the detected reflected light with respect to the emitted light. Then, the image processing unit 8 calculates a distance d or generally depth information for the scene 6, for example, to the object 7 based on the determined phase-shift.

The depth information (distance) for the scene 6 is fed from the image processing unit 8 to the 3D reconstruction unit 9, which constructs (generates) a 3D image, 3D depth map or 3D point cloud of the scene 6 based on the depth information from the image processing unit 8.

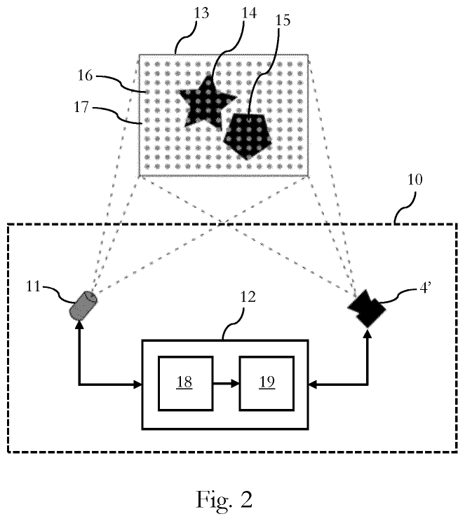

For further enhancing the general understanding of the present disclosure, an embodiment of an iToF system 10 with a spot illuminator 11 is discussed under reference of FIG. 2, there the embodiment of the iToF system 10 is schematically illustrated in a block diagram.

The iToF system 10 is a spot iToF system for depth sensing or providing a distance measurement. The iToF system 10 includes a spot illuminator 11, a control unit 12 and a ToF sensor 4′.

The spot illuminator 11 provides a spotted illumination to a scene 13, including objects 14 and 15, such that the scene 13 is illuminated with spatially modulated light. In other words, the spot illuminator 11 emits spotted light to the scene 13, which is reflected at least in parts by the objects 14 and 15.

The spotted illumination is basically light having a spatial light pattern including high-intensity areas 16 and low-intensity areas 17 and, thus, a plurality of light spots corresponding to the high-intensity areas 16 is projected onto the scene 13. The plurality of light spots may have a spatial light intensity profile, for example, a Gaussian light intensity profile or the like.

Moreover, the spot illuminator 11 emits the spatially modulated light in an intensity-modulated manner (in time) to the scene 13, wherein the spot illuminator 11 modulates the light in time based on a modulation signal obtained from the control unit 12.

The control unit 12 controls the overall operation of the iToF system 10 and includes an image processing unit 18 and a 3D image reconstruction unit 19.

The control unit 12 controls the light emission timing of the spot illuminator 11 based on a modulation signal (which may be e.g. a rectangular modulation signal having a modulation period 1) applied to the spot illuminator 11. The control unit 12 applies a demodulation signal to the ToF sensor 4′ which corresponds to the modulation signal applied to spot illuminator 11. The control unit 12 applies four demodulation signals to the ToF sensor 4′ corresponding to four phase shifts (0°, 90°, 180° and 270°) between the modulation signal and the demodulation signal for capturing four frames.

The ToF sensor 4′ corresponds to the ToF sensor 4 of the embodiment discussed under reference of FIG. 1 including the optical lens portion 5. The ToF sensor 4′ generates ToF data corresponding to the four frames including pixel values of a plurality of pixels generated in accordance with an amount of reflected light imaged by the optical lens portion 5 onto each of the pixels and in accordance with the demodulation signal.

The image processing unit 18 obtains the ToF data from the ToF sensor 4′. The image processing unit 18 determines, based on the obtained ToF data, a phase-shift of the detected reflected light with respect to the emitted light. Then, the image processing unit 18 calculates a distance d or generally depth information for the scene 13, for example, to the objects 14 and 15 based on the determined phase-shift.

The depth information (distance) for the scene 13 is fed from the image processing unit 18 to the 3D reconstruction unit 19, which constructs (generates) a 3D image, 3D depth map or 3D point cloud of the scene 13 based on the depth information from the image processing unit 18.

Returning to the general explanations, it has been recognized that ToF systems with a full-field illuminator may provide a higher spatial resolution compared to ToF systems with a spot illuminator, however, it has been recognized that ToF systems with the spot illuminator may provide a higher depth accuracy and precision compared to ToF systems with the full-field illuminator. Generally, it has been recognized that a spotted illumination may allow to achieve a higher signal-to-noise ratio and thus less depth noise (depth precision) and may allow to improve accuracy by reducing multipath interference.

Hence, it has been recognized that a ToF module, which integrates a full-field and a spot illuminator, should be provided in order to combine both measurement characteristics in a single module.

However, it has been further recognized that such a modular integration requires, for example, considering technical and design constraints, effects on the measurement characteristics due to different layouts or relative arrangements of the illuminators and the ToF sensor, and data acquisition and data processing synchronization requirements.

For example, in the data acquisition process, the operation of two different illuminators have to be controlled and their operation needs to be synchronized and coordinated among each other and with respect to the ToF sensor. For example, in the data processing, the ToF data of both measurements may need to be processed simultaneously for obtaining the depth information.

It has been recognized that in a ToF module which integrates a full-field and a spot illuminator, a distance between a ToF sensor and each of the full-field and spot illuminator should be as small as possible as achievable by conventional manufacturing methods.

However, typically a light source driver of the illuminators may be placed close to the illuminator which requires some space on a circuit board and, thus, may limit how close ToF sensors and illuminators can be arranged.

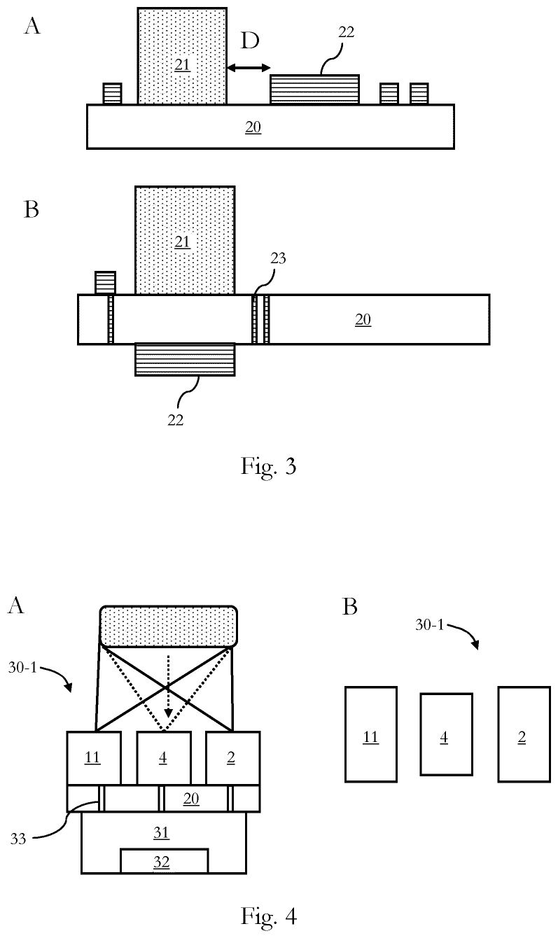

FIG. 3 schematically illustrates in a block diagram in FIG. 3A a first embodiment of a light source driver 22 and in FIG. 3B a second embodiment of the light source driver 22.

As schematically shown in FIG. 3A, an illuminator 21 and the corresponding light source driver 22 are arranged on a printed circuit board 20.

Typically, this is a simple arrangement which provides a direct interconnect with no layer change which is easy to decouple.

However, such an arrangement would limit how close the ToF sensor and two different illuminators can be arranged.

As schematically shown in FIG. 3B, the light source driver 22 and the illuminator 21 are arranged in top-bottom topology on different sides of the printed circuit board 20 and are connected via interconnects 23.

This arrangement may allow a closer distance between the ToF sensor and two different illuminators. However, a quality of the interconnects may determine an electrical performance such as switching speed, voltage drop, etc.

Hence, technical constraints need to be taken into account when a ToF module with switchable illumination is provided.

Moreover, for the use of the integrated ToF module in various products, design constraints such as spatial dimensions demanded by the product manufacturer may have to be taken into account. Thus, different layouts or relative arrangements may be demanded, however, it has been recognized that different relative arrangements may have different characteristics such that an optimal trade-off solution between design and technical considerations may be required.

Hence, some embodiments pertain to a time-of-flight module with switchable illumination for a scene, including:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene; and
a control unit configured to switch between the full-field illumination and the spotted illumination provided to the scene;
wherein the full-field illuminator and the spot illuminator are arranged adjacent to the time-of-flight sensor.

The time-of-flight module may be provided on a single circuit board such that the ToF can be plugged in an embedding device. The embedding device may be a head mounted display, a virtual reality display, a security camera, a mobile device such as a laptop, a tablet, etc. The ToF module may have a connector for plugging the ToF module in a corresponding connector in the embedding device. The connector may include a data bus and the ToF module may have a data bus interface for transmitting data over the data bus to the embedding device, for example, to an application processor of the embedding device.

The data bus interface may be, for example, a Camera Serial Interface (CSI) in accordance with MIPI (Mobile Industry Processor Interface) specifications (e.g. MIPII CSI-2 or the like), an I²C (Inter-Integrated Circuit) interface, a Controller Area Network (CAN) bus interface, an FDP-link (Flat Panel Display link), a GSML (Gigabit Multimedia Serial Link), etc. The data bus is in accordance with the corresponding interface specifications.

The time-of-flight sensor may include a pixel circuitry with a plurality of pixels and read-out circuitry and optical parts such as a lens, microlenses, or the like. The plurality of pixels may be arranged in rows and columns as an array or the like. The plurality of pixels may be current assisted photonic demodulator (CAPD) pixels, single photon avalanche diode (SPAD) pixels, photodiode pixels or active pixels based on, for example, CMOS (complementary metal oxide semiconductor) technology, etc. Two embodiments of a ToF sensor have also been discussed under reference of FIGS. 1 and 2.

The time-of-flight data may be pixel values of each of the plurality of pixels of one or more frames or component data or a histogram. Two embodiments of ToF data have also been discussed under reference of FIGS. 1 and 2. The ToF data represent a ToF measurement and, thus, a ToF image.

The full-field illuminator may include a light source or light source elements and may include optical parts such as lenses or the like. The light source or the light source elements may be a laser such as a laser diode, a plurality of laser diodes which may be arranged in rows and columns as an array, a light emitting diode, a plurality of light emitting diodes arranged as an array, or the like. The full-field illuminator may emit visible light or infrared light, etc. An embodiment of a full-field illuminator has also been discussed under reference of FIG. 1.

The full-field illumination corresponds to a continuous spatial light profile provided to the scene.

The spot illuminator may include a light source or light source elements and may include optical parts such as lenses or the like. The light source or the light source elements may be a laser such as a laser diode, a plurality of laser diodes which may be arranged in rows and columns as an array, a light emitting diode, a plurality of light emitting diodes arranged as an array, or the like. The spot illuminator may emit visible light or infrared light, etc. An embodiment of a spot illuminator has also been discussed under reference of FIG. 2.

The spotted illumination corresponds to a light pattern of (separated) high-intensity and low-intensity (or substantially zero-intensity) areas such as a pattern of light spots provided to the scene.

The control unit basically controls the overall operation of the ToF module. The control unit can switch the full-field illuminator and the spot illuminator on/off such that the illumination for the scene is switchable.

The control unit may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like. The functionality may be implemented by software executed by a processor such as an application processor or the like. The control unit may be based on or may include or may be implemented by typical electronic components configured to achieve the functionality as described herein. The control unit may be based on or may include or may be implemented in parts by typical electronic components and integrated circuitry logic and in parts by software.

The control unit may include data storage capabilities to store data such as memory which may be based on semiconductor storage technology (e.g. RAM, EPROM, etc.) or magnetic storage technology (e.g. a hard disk drive) or the like.

The control unit may include a data bus interface for transmitting data over a data bus such as MIPII CSI-2 or the like.

The full-field illuminator and the spot illuminator are arranged adjacent to the ToF sensor.

Both the full-field illuminator and the spot illuminator should be as close as possible—as achievable by conventional manufacturing methods—to the ToF sensor for reducing a parallax between each of the illuminators and the ToF sensor.

Due to the use of a common adjacent ToF sensor for the frill-field and the spotted illumination, a simple value registration between both ToF measurements (or ToF images or ToF data) may be provided. Moreover, a depth map that is less sensitive to multipath contributions may be generated.

In some embodiments, a field-of-illumination of each of the frill-field illuminator and the spot illuminator covers a field-of-view of the time-of-flight sensor.

The field-of-illumination is that part of a scene which is illuminated with light emitted by an illuminator. The field-of-view is that part of a scene which is imaged by the ToF sensor. In some embodiments, the field-of-view has a rectangular shape. In some embodiments, the field-of-illumination has a rectangular shape.

Generally, when a distance of an illuminator to the ToF sensor may become too large, the provided illumination may have a larger angle to the field-of-view of the ToF sensor and, thus, an overlap of field-of-illumination and field-of-view may decrease such that a fraction of reflected light that can be imaged by the ToF sensor may decrease. Thus, both the full-field illuminator and the spot illuminator should be as close as possible to the ToF sensor.

In some embodiments, a distance between the time-of-flight sensor and the full-field illuminator and a distance between the time-of-flight sensor and the spot illuminator are substantially equal.

This may reduce a parallax between ToF data of a ToF measurement performed with full-field illumination and ToF data of a ToF measurement performed with spotted illumination such that a comparability between both ToF data may be increased and, thus, an accuracy of a depth map obtained from the ToF data may be increased.

In some embodiments, the time-of-flight sensor, the full-field illuminator and the spot illuminator are arranged in a first line.

This may be a design option which may depend on technical specifications of a product manufacture which may want to include the ToF module in a product.

Moreover, this may allow a simpler configuration in which the field-of-illumination of the full-field illuminator and the field-of-illumination of the spot illuminator both cover the field-of-view of the ToF sensor, in particular for rectangular shaped ToF sensors and illuminators.

Thus, in some embodiments, each of the time-of-flight sensor, the full-field illuminator and the spot illuminator has a rectangular shape and a larger side of the time-of-flight sensor faces a larger side of each of the full-field illuminator and the spot illuminator.

The rectangular shape may refer to an arrangement of pixels of the ToF sensor (e.g. a pixel array) and an arrangement of light source elements (e.g. an LED array). The largest side may refer to the largest side of such an array.

Generally, time-of-flight data may be combined in data analysis or data processing with image data of the same scene for improving depth information accuracy or the like.

Hence, in some embodiments, the time-of-flight module further includes a first image sensor configured to generate first image data representing a first image of the scene, wherein the first image sensor is arranged adjacent to the time-of-flight sensor in a direction orthogonal to the first line.

The first image sensor may be a CCD (charge-coupled device) sensor or an active-pixel sensor based on CMOS technology or the like. The first image sensor may be a color image sensor (e.g. an RGB sensor). The first image sensor may include a plurality of pixels and read-out circuitry and may include optical parts such as a lens, microlenses, or the like. The plurality of pixels may be arranged in rows and columns as an array or the like.

The first image data may include pixel values of each of the plurality of pixels representing a two-dimensional first image of the scene.

The arrangement of the first image sensor adjacent to the ToF sensor may reduce a parallax between the first image and ToF data representing a ToF measurement (and thus a depth map) of the scene and, thus, may increase a comparability between them and, thus, an accuracy of the depth may be increased.

It has been recognized that integrating an additional first image sensor may further increase data acquisition synchronization and coordination requirements, however, as discussed, it may increase depth map accuracy such that a trade-off solution is obtained.

Generally, time-of-flight data may be combined in data analysis or data processing with depth information obtained from a stereo imaging. Basically, stereo imaging involves capturing two images of a scene from two different positions such that depth information is obtained from the parallax between them.

Hence, in some embodiments, the time-of-flight module further includes a second image sensor configured to generate second image date representing a second image of the scene, wherein the first image sensor, the second image sensor and the time-of-flight sensor are arranged in a second line which is orthogonal to the first line.

The second image sensor may be a CCD (charge-coupled device) sensor or an active-pixel sensor based on CMOS technology or the like. The second image sensor may be a color image sensor (e.g. an RGB sensor). The second image sensor may include a plurality of pixels and read-out circuitry and may include optical parts such as a lens, microlenses, or the like. The plurality of pixels may be arranged in rows and columns as an array or the like.

The second image data may include pixel values of each of the plurality of pixels representing a two-dimensional second image of the scene.

The first image and the second image are obtained at different positions such that depth information can be obtained from that stereo imaging. The depth information can be correlated with the depth map from the ToF data which may increase accuracy.

Moreover, in cases in which ambient is sufficient, depth information may be obtained from stereo imaging alone. In cases in which ambient is insufficient, the control unit may switch on ToF measurement. This may reduce power consumption of the ToF module while maintaining its ability for depth information generation.

In some embodiments, the first image sensor is on a first side of the time-of-flight sensor and the second image sensor is on a second side of the time-of-flight sensor.

In such embodiments, the image sensors are on both sides of the ToF sensor which allows maximizing a distance between them and may thus increase depth information accuracy. However, this may increase a parallax between ToF image and stereo image. But, it may provide a reasonable trade-off solution, since stereo imaging may be improved while parallax with the ToF sensor may still be acceptable.

Hence, in some embodiments, a distance between the time-of-flight sensor and at least one of the first and the second image sensor is larger than a distance between the time-of-flight sensor and each of the full-field illuminator and the spot illuminator.

In some embodiments, the time-of-flight sensor, the first image sensor and the second image sensor have a proportional field-of-view. For example, a width and a height of the field-of-view are proportional even if resolution may be different.

This may increase a comparability and, thus, may increase depth information or depth map accuracy.

An alternative arrangement to the provision of the ToF sensor and the illuminators in a first line is discussed in the following.

In some embodiments, the full-field illuminator is adjacent to the time-of-flight sensor in a first direction and the spot illuminator is arranged adjacent to the time-of-flight sensor in a second direction orthogonal to the first direction.

This may be a design option which may depend on technical specifications of a product manufacture which may want to include the ToF module in a product. It may provide a more compact layout in two dimensions.

In some embodiments, the time-of-flight module further includes a first image sensor configured to generate first image data representing a first image of the scene, wherein the first image sensor is arranged adjacent to the time-of-flight sensor such that the time-of-flight sensor, the first image sensor and the full-field illuminator or the time-of-flight sensor, the first image sensor and the spot illuminator are arranged in a line.

An alternative arrangement to these embodiments is that in some embodiments, the time-of-flight module further includes a first image sensor configured to generate first image data representing a first image of the scene, wherein the first image sensor is arranged adjacent to the full-field illuminator and the spot illuminator.

This arrangement may allow a more compact design in two dimensions depending, for example, on technical specifications of a product manufacturer.

As discussed above, the provision of a second image sensor allows stereo imaging to obtain additional or alternative depth information of the scene.

Hence, in some embodiments, the time-of-flight module further includes a second image sensor configured to generate second image data representing a second image of the scene, wherein the second image sensor is arranged in the line.

An alternative arrangement in which the time-of-flight sensor, the full-field illuminator, the spot illuminator and an image sensor are arranged in a line and in which the illuminators sandwich the ToF sensor and the image sensor may reduce a parallax between ToF data and a two-dimensional image obtained with the image sensor which may increase comparability between them.

Hence, some embodiments pertain to a time-of-flight module with switchable illumination for a scene, including:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene;
a control unit configured to switch between the full-field illumination and the spotted illumination provided to the scene; and
an image sensor configured to generate image data representing an image of the scene;
wherein the time-of-flight sensor, the full-field illuminator, the spot illuminator and the image sensor are arranged in a line, wherein the time-of-flight sensor and the image sensor are arranged adjacent to each other.

It has further been recognized that a single illuminator that is switchable between full-field and spotted illumination may further reduce a parallax between the two ToF measurements with different illumination and may reduce the dimensions of the ToF module due to a more compact design.

Hence, some embodiments pertain to a time-of-flight module with switchable illumination for a scene, including:
a time-of-flight sensor configured to generate time-of-flight data representing a time-of-flight measurement of light reflected from the scene; and
a switchable illuminator configured to provide either a full-field illumination or a spotted illumination to the scene based on an illumination switch command obtained from a control unit; wherein
the control unit is configured to transmit the illumination switch command to the switchable illuminator for switching between the frill-field illumination and the spotted illumination provided to the scene; and
the switchable illuminator is arranged adjacent to the time-of-flight sensor.

In some embodiments, the time-of-flight module further includes a first image sensor configured to generate first image data representing a first image of the scene, wherein the time-of-flight sensor, the switchable illuminator and the first image sensor are arranged in a line.

In some embodiments, the time-of-flight module further includes a second image sensor configured to generate second image data representing a second image of the scene, wherein the second image sensor is arranged in the line.

In some embodiments, the first image sensor is on a first side of the time-of-flight sensor and the second image sensor is on a second side of the time-of-flight sensor, wherein a distance between the switchable illuminator and the first image sensor and a distance between the switchable illuminator and the second image sensor are substantially equal.

An alternative arrangement which may allow a more compact design in two dimensions is that in some embodiments, the time-of-flight module further includes a first image sensor configured to generate first image data representing a first image of the scene, wherein the switchable illuminator is arranged adjacent to the time-of-flight sensor in a first direction and the first image sensor is arranged adjacent to the time-of-flight sensor in a second direction orthogonal to the first direction.

Returning to FIG. 4, schematically illustrates in a block diagram in FIG. 4A a first embodiment of a ToF module 30-1 and in FIG. 4B a top view corresponding to the first embodiment of the ToF module 30-1.

As schematically shown in FIG. 4A, the ToF module 30-1 includes a printed circuit board (PCB) 20 on which a ToF sensor 4 (such as the ToF sensor 4 or 4′ of FIG. 1 and FIG. 2, respectively), a full-field illuminator 2 (such as the full-field illuminator of FIG. 1) and a spot illuminator 11 (such as the spot illuminator of FIG. 2) are arranged on a first side and on which a control unit 31 is arranged on a second side of the PCB 20.

The full-field illuminator 2 and the spot illuminator 11 are arranged adjacent to the ToF sensor 4 and the full-field illuminator 2, the spot illuminator 11 and the ToF sensor 4 are arranged in a line.

The control unit 31 is connected with the ToF sensor 4, the full-field illuminator 2 and the spot illuminator 11 via interconnects 33 in the PCB 20.

The full-field illuminator 2 provides a full-field illumination to a scene. The full-field illuminator 2 has a field-of-illumination (illustrated by the dotted box) which covers a field-of-view of the ToF sensor 4 (illustrated by the dotted lines).

The spot illuminator 11 provides a spotted illumination to the scene. The spot illuminator 11 has a field-of-illumination (also illustrated by the dotted box) which also covers the field-of-view of the ToF sensor 4.

The ToF sensor 4 generates ToF data representing a ToF measurement of light reflected from the scene for both types of illumination.

The control unit 31 controls the overall operation of the ToF module 30-1 and switches between the full-field illumination and the spotted illumination and coordinates data acquisition.

Moreover, the control unit 31 includes a data bus interface 32 for transmitting data over a data bus (not shown). At the data bus interface 32, the ToF module 30-1 can be plugged in an embedding device such as a head mounted display or virtual reality device.

Thus, the ToF module 30-1 combines a high spatial resolution in a depth measurement due to the full-field illuminator 2 and a high depth resolution in a depth measurement due to the spot illuminator 11 in a single module.

In FIG. 4B, a top view of the ToF module 30-1 is shown schematically in a block diagram.

Each of the ToF sensor 4, the full-field illuminator 2 and the spot illuminator 11 has a rectangular shape and a larger side of the ToF sensor 4 faces a larger side of each of the full-field illuminator 2 and the spot illuminator 11.

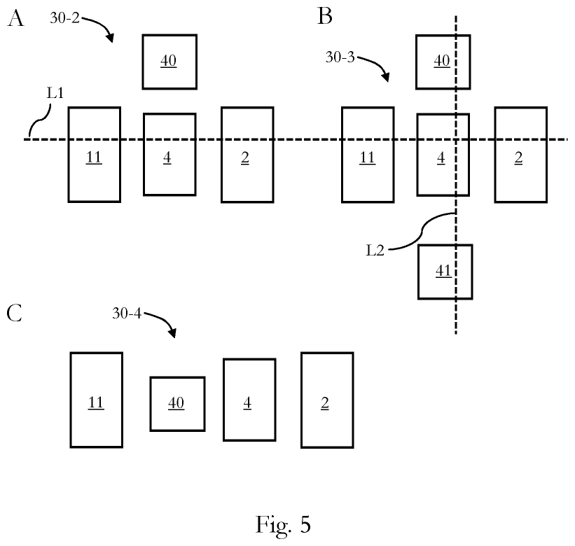

FIG. 5 schematically illustrates in a block diagram in FIG. 5A a top view of a second embodiment of a time-of-flight module 30-2, in FIG. 5B a top view of a third embodiment of a time-of-flight module 30-3, and in FIG. 5C a top view of a fourth embodiment of a time-of-flight module 30-4.

In FIG. 5A, a top view of the ToF module 30-2 is shown schematically in a block diagram.

The ToF module 30-2 includes a full-field illuminator 2, a ToF sensor 4, a spot illuminator 11 and a first image sensor 40.

The image sensor 40 generates first image data representing a first image of a scene.

The full-field illuminator 2 and the spot illuminator 11 are arranged adjacent to the ToF sensor 4 and the full-field illuminator 2, the spot illuminator 11 and the ToF sensor 4 are arranged in a first line L1.

The first image sensor 40 is arranged adjacent to the ToF sensor 4 in a direction orthogonal to the first line L1.

Thus, a parallax between the first image of the first image sensor 40 and a ToF image represented by ToF data of the ToF sensor 4.

In FIG. 5B, a top view of the ToF module 30-3 is shown schematically in a block diagram.

The ToF module 30-3 corresponds to the ToF module 30-2 of FIG. 5A, wherein the ToF module 30-3 includes a second image sensor 41.

The first image sensor 40, the second image sensor 41 and the ToF sensor 4 are arranged in a second line L2 which is orthogonal to the first line L1.

The first image sensor 40 is on a first side of the ToF sensor 4 and the second image sensor 41 is on a second side of the ToF sensor 4.

A distance between the ToF sensor 4 and the second image sensor 41 is larger than a distance between the ToF sensor 4 and each of the full-field illuminator 2 and the spot illuminator 11.

Thus, the ToF module 30-3 supports stereo imaging by the first image sensor 40 and the second image sensor 41.

In FIG. 5C, a top view of the ToF module 30-4 is shown schematically in a block diagram.

The full-field illuminator 2, the ToF sensor 4, the spot illuminator 11 and the first image sensor 40 correspond to the respective entities of FIGS. 5A and 5B.

The ToF sensor 4, the full-field illuminator 2, the spot illuminator 11 and the first image sensor 40 are arranged in a line, wherein the ToF sensor 4 and the first image sensor 40 are arranged adjacent to each other.

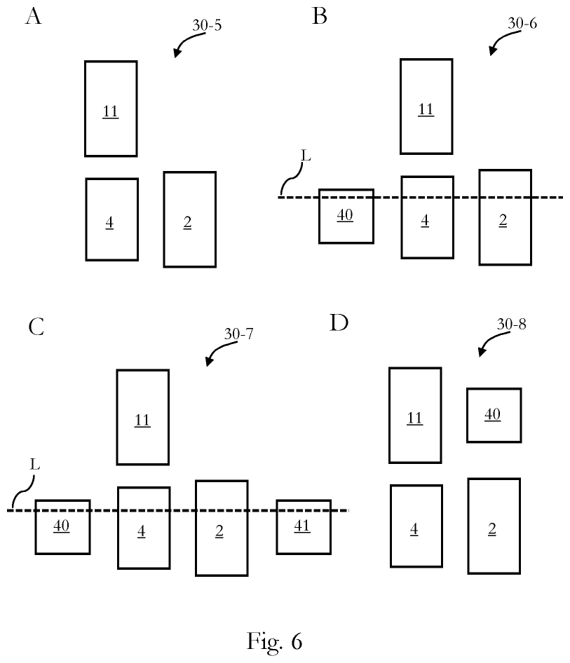

FIG. 6 schematically illustrates in a block diagram in FIG. 6A a top view of a fifth embodiment of a time-of-flight module 30-5, in FIG. 6B a top view of a sixth embodiment of a time-of-flight module 30-6, in FIG. 6C a top view of a seventh embodiment of a time-of-flight module 30-7, and in FIG. 6D a top view of a eight embodiment of a time-of-flight module 30-8.

In FIG. 6A, a top view of the ToF module 30-5 is shown schematically in a block diagram.

The ToF module 30-5 includes a full-field illuminator 2, a ToF sensor 4 and a spot illuminator 11 which correspond to respective entities in previous embodiments.

The full-field illuminator 2 is arranged adjacent to the ToF sensor 4 in a first direction and the spot illuminator 11 is adjacent to the ToF sensor 4 in a second direction.

In FIG. 6B, a top view of the ToF module 30-6 is shown schematically in a block diagram.

The ToF module corresponds to the ToF module 30-5 of FIG. 6A, wherein the ToF module 30-6 includes a first image sensor 40.

The first image sensor 40 is arranged adjacent to the ToF sensor 4 such that the ToF sensor 4, the first image sensor 40 and the full-field illuminator 2 are arranged in a line L.

In FIG. 6C, a top view of the ToF module 30-7 is shown schematically in a block diagram.

The ToF module 30-7 corresponds to the ToF module 30-6 of FIG. 6B, wherein the ToF module 30-7 includes a second image sensor 41.

The second image sensor 41 is arranged in the line L.

In FIG. 6D, a top view of the ToF module 30-8 is shown schematically in a block diagram.

The ToF module corresponds to the ToF module 30-5 of FIG. 6A, wherein the ToF module 30-8 includes a first image sensor 40.

The first image sensor 40 is arranged adjacent to the full-field illuminator 2 and the spot illuminator 11.

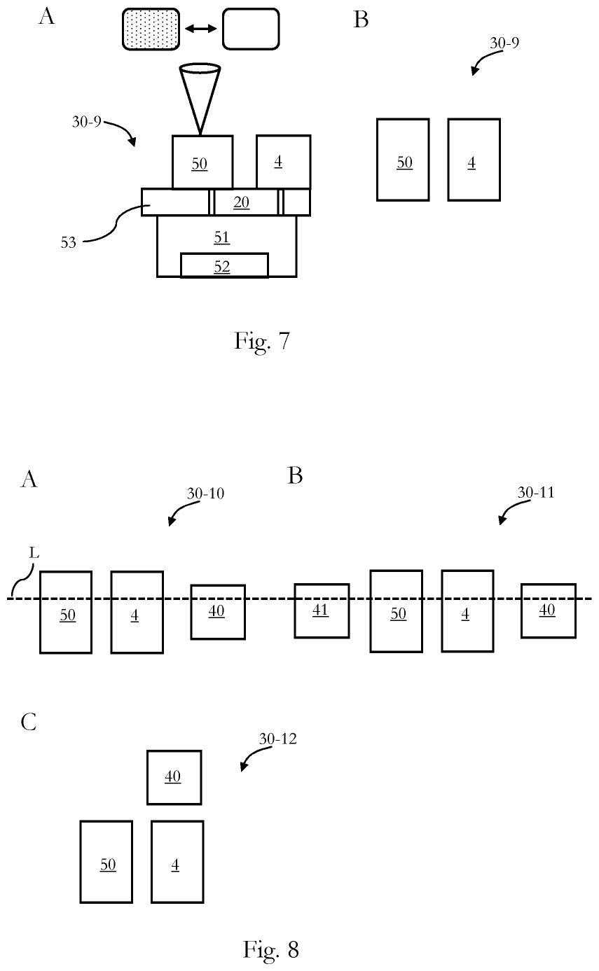

FIG. 7 schematically illustrates in a block diagram in FIG. 7A a nineth embodiment of a time-of-flight module 30-9, and in FIG. 7B a top view corresponding to the nineth embodiment of the time-of-flight module 30-9.

As schematically shown in FIG. 7A, the ToF module 30-9 includes a printed circuit board (PCB) 20 on which a ToF sensor 4 (such as the ToF sensor 4 or 4′ of FIG. 1 and FIG. 2, respectively) and a switchable illuminator 50 are arranged on a first side and on which a control unit 51 is arranged on a second side of the PCB 20.

The switchable illuminator 50 is arranged adjacent to the ToF sensor 4, as also shown in a top view in FIG. 7B.

The control unit 51 is connected with the ToF sensor 4 and the switchable illuminator 50 via interconnects 53 in the PCB 20.

The switchable illuminator 50 provides either a full-field illumination or a spotted illumination (illustrated by the boxes) to a scene based on an illumination switching command obtained from the control unit 51. The switchable illuminator 50 has a field-of-illumination which covers a field-of-view of the ToF sensor 4.

The ToF sensor 4 generates ToF data representing a ToF measurement (or a ToF image) of light reflected from the scene for both types of illumination.

The control unit 51 controls the overall operation of the ToF module 30-1 and switches between the full-field illumination and the spotted illumination by transmitting the illumination switch command to the switchable illuminator 50 and coordinates data acquisition.

Moreover, the control unit 51 includes a data bus interface 52 for transmitting data over a data bus (not shown). At the data bus interface 52, the ToF module 30-9 can be plugged in an embedding device such as a head mounted display or virtual reality device.

Thus, the ToF module 30-1 combines a high spatial resolution and high depth accuracy and precision in a depth measurement due to the switchable illuminator 50 in a single module.

FIG. 8 schematically illustrates in a block diagram in FIG. 8A a top view of a tenth embodiment of a time-of-flight module 30-10, in FIG. 8B a top view of an eleventh embodiment of a time-of-flight module 30-11, and in FIG. 8C a top view of a twelfth embodiment of a time-of-flight module 30-12.

In FIG. 8A, a top view of the ToF module 30-10 is shown schematically in a block diagram.

The ToF module corresponds to the ToF module 30-9 of FIGS. 7A and 7B, wherein the ToF module 30-10 includes a first image sensor 40.

The first image sensor 40, the ToF sensor 4 and the switchable illuminator 50 are arranged in a line L.

In FIG. 8B, a top view of the ToF module 30-11 is shown schematically in a block diagram.

The ToF module 30-11 corresponds to the ToF module 30-10 of FIG. 8A, wherein the ToF module 30-11 includes a second image sensor 41.

The second image sensor 41 is arranged in the line L.

In FIG. 8C, a top view of the ToF module 30-12 is shown schematically in a block diagram.

The ToF module 30-12 is based on the ToF module 30-10 of FIG. 8A, however, in the ToF module 30-12, the switchable illuminator 50 is arranged adjacent to the ToF sensor 4 in a first direction and the first image sensor 40 is arranged adjacent to the ToF sensor 4 in a second direction orthogonal to the first direction.

Please note that the division of the control unit 3 into units 8 and 9 is only made for illustration purposes and that the present disclosure is not limited to any specific division of functions in specific units. For instance, the control unit 3 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight module with switchable illumination for a scene, including:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene; and
a control unit configured to switch between the full-field illumination and the spotted illumination provided to the scene;
wherein the full-field illuminator and the spot illuminator are arranged adjacent to the time-of-flight sensor.

(2) The time-of-flight module of (1), wherein the time-of-flight sensor, the full-field illuminator and the spot illuminator are arranged in a first line.

(3) The time-of-flight module of (2), wherein each of the time-of-flight sensor, the full-field illuminator and the spot illuminator has a rectangular shape and a larger side of the time-of-flight sensor faces a larger side of each of the full-field illuminator and the spot illuminator.

(4) The time-of-flight module of (3), further including:
a first image sensor configured to generate first image data representing a first image of the scene;
wherein the first image sensor is arranged adjacent to the time-of-flight sensor in a direction orthogonal to the first line.

(5) The time-of-flight module of (4), further including:
a second image sensor configured to generate second image date representing a second image of the scene;
wherein the first image sensor, the second image sensor and the time-of-flight sensor are arranged in a second line which is orthogonal to the first line.

(6) The time-of-flight module of (5), wherein the first image sensor is on a first side of the time-of-flight sensor and the second image sensor is on a second side of the time-of-flight sensor.

(7) The time-of-flight module of (6), wherein a distance between the time-of-flight sensor and at least one of the first and the second image sensor is larger than a distance between the time-of-flight sensor and each of the full-field illuminator and the spot illuminator.

(8) The time-of-flight module anyone of (5) to (7), wherein the time-of-flight sensor, the first image sensor and the second image sensor have a proportional field-of-view.

(9) The time-of-flight module of (1), wherein the full-field illuminator is adjacent to the time-of-flight sensor in a first direction and the spot illuminator is arranged adjacent to the time-of-flight sensor in a second direction orthogonal to the first direction.

(10) The time-of-flight module of (9), further including:
a first image sensor configured to generate first image data representing a first image of the scene;
wherein the first image sensor is arranged adjacent to the time-of-flight sensor such that the time-of-flight sensor, the first image sensor and the full-field illuminator or the time-of-flight sensor, the first image sensor and the spot illuminator are arranged in a line.

(11) The time-of-flight module of (10), further including:
a second image sensor configured to generate second image data representing a second image of the scene;
wherein the second image sensor is arranged in the line.

(12) The time-of-flight module of (9), further including:
a first image sensor configured to generate first image data representing a first image of the scene;
wherein the first image sensor is arranged adjacent to the full-field illuminator and the spot illuminator.

(13) The time-of-flight module of anyone of (1) to (12), wherein a distance between the time-of-flight sensor and the full-field illuminator and a distance between the time-of-flight sensor and the spot illuminator are substantially equal.

(14) The time-of-flight module of anyone of (1) to (13), wherein a field-of-illumination of each of the full-field illuminator and the spot illuminator covers a field-of-view of the time-of-flight sensor.

(15) A time-of-flight module with switchable illumination for a scene, including:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene;
a control unit configured to switch between the full-field illumination and the spotted illumination provided to the scene; and
an image sensor configured to generate image data representing an image of the scene;
wherein the time-of-flight sensor, the full-field illuminator, the spot illuminator and the image sensor are arranged in a line, wherein the time-of-flight sensor and the image sensor are arranged adjacent to each other.

(16) A time-of-flight module with switchable illumination for a scene, including:
a time-of-flight sensor configured to generate time-of-flight data representing a time-of-flight measurement of light reflected from the scene; and
a switchable illuminator configured to provide either a full-field illumination or a spotted illumination to the scene based on an illumination switch command obtained from a control unit; wherein
the control unit is configured to transmit the illumination switch command to the switchable illuminator for switching between the frill-field illumination and the spotted illumination provided to the scene; and
the switchable illuminator is arranged adjacent to the time-of-flight sensor.

(17) The time-of-flight module of (16), further including:
a first image sensor configured to generate first image data representing a first image of the scene;
wherein the time-of-flight sensor, the switchable illuminator and the first image sensor are arranged in a line.

(18) The time-of-flight module of (17), further including:
a second image sensor configured to generate second image data representing a second image of the scene;
wherein the second image sensor is arranged in the line.

(19) The time-of-flight module of (18), wherein the first image sensor is on a first side of the time-of-flight sensor and the second image sensor is on a second side of the time-of-flight sensor, wherein a distance between the switchable illuminator and the first image sensor and a distance between the switchable illuminator and the second image sensor are substantially equal.

(20) The time-of-flight module of (16), further including:
a first image sensor configured to generate first image data representing a first image of the scene;
wherein the switchable illuminator is arranged adjacent to the time-of-flight sensor in a first direction and the first image sensor is arranged adjacent to the time-of-flight sensor in a second direction orthogonal to the first direction.

1. A time-of-flight module with switchable illumination for a scene, comprising:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene; and
a control unit configured to switch between the full-field illumination and the spotted illumination provided to the scene;
wherein the full-field illuminator and the spot illuminator are arranged adjacent to the time-of-flight sensor.

2. The time-of-flight module according to claim 1, wherein the time-of-flight sensor, the full-field illuminator and the spot illuminator are arranged in a first line.

3. The time-of-flight module according to claim 2, wherein each of the time-of-flight sensor, the full-field illuminator and the spot illuminator has a rectangular shape and a larger side of the time-of-flight sensor faces a larger side of each of the full-field illuminator and the spot illuminator.

4. The time-of-flight module according to claim 3, further comprising:
a first image sensor configured to generate first image data representing a first image of the scene;
wherein the first image sensor is arranged adjacent to the time-of-flight sensor in a direction orthogonal to the first line.

5. The time-of-flight module according to claim 4, further comprising:
a second image sensor configured to generate second image date representing a second image of the scene;
wherein the first image sensor, the second image sensor and the time-of-flight sensor are arranged in a second line which is orthogonal to the first line.

6. The time-of-flight module according to claim 5, wherein the first image sensor is on a first side of the time-of-flight sensor and the second image sensor is on a second side of the time-of-flight sensor.

7. The time-of-flight module according to claim 6, wherein a distance between the time-of-flight sensor and at least one of the first and the second image sensor is larger than a distance between the time-of-flight sensor and each of the full-field illuminator and the spot illuminator.

8. The time-of-flight module according to claim 5, wherein the time-of-flight sensor, the first image sensor and the second image sensor have a proportional field-of-view.

9. The time-of-flight module according to claim 1, wherein the full-field illuminator is arranged adjacent to the time-of-flight sensor in a first direction and the spot illuminator is adjacent to the time-of-flight sensor in a second direction orthogonal to the first direction.

10. The time-of-flight module according to claim 9, further comprising:
a first image sensor configured to generate first image data representing a first image of the scene;
wherein the first image sensor is arranged adjacent to the time-of-flight sensor such that the time-of-flight sensor, the first image sensor and the full-field illuminator or the time-of-flight sensor, the first image sensor and the spot illuminator are arranged in a line.

11. The time-of-flight module according to claim 10, further comprising:
a second image sensor configured to generate second image data representing a second image of the scene;
wherein the second image sensor is arranged in the line.

12. The time-of-flight module according to claim 9, further comprising:
a first image sensor configured to generate first image data representing a first image of the scene;
wherein the first image sensor is arranged adjacent to the full-field illuminator and the spot illuminator.

13. The time-of-flight module according to claim 1, wherein a distance between the time-of-flight sensor and the full-field illuminator and a distance between the time-of-flight sensor and the spot illuminator are substantially equal.

14. The time-of-flight module according to claim 1, wherein a field-of-illumination of each of the full-field illuminator and the spot illuminator covers a field-of-view of the time-of-flight sensor.

15. A time-of-flight module with switchable illumination for a scene, comprising:
a time-of-flight sensor configured to generate time-of-flight data representing a time-of-flight measurement of light reflected from the scene;
a full-field illuminator configured to provide a full-field illumination to the scene;
a spot illuminator configured to provide a spotted illumination to the scene;
a control unit configured to switch between the full-field illumination and the spotted illumination provided to the scene; and
an image sensor configured to generate image data representing an image of the scene;
wherein the time-of-flight sensor, the full-field illuminator, the spot illuminator and the image sensor are arranged in a line, wherein the time-of-flight sensor and the image sensor are arranged adjacent to each other.

16. A time-of-flight module with switchable illumination for a scene, comprising:
a time-of-flight sensor configured to generate time-of-flight data representing a time-of-flight measurement of light reflected from the scene; and
a switchable illuminator configured to provide either a full-field illumination or a spotted illumination to the scene based on an illumination switch command obtained from a control unit; wherein
the control unit is configured to transmit the illumination switch command to the switchable illuminator for switching between the frill-field illumination and the spotted illumination provided to the scene; and
the switchable illuminator is arranged adjacent to the time-of-flight sensor.

17. The time-of-flight module according to claim 16, further comprising:
a first image sensor configured to generate first image data representing a first image of the scene;
wherein the time-of-flight sensor, the switchable illuminator and the first image sensor are arranged in a line.

18. The time-of-flight module according to claim 17, further comprising:
a second image sensor configured to generate second image data representing a second image of the scene;
wherein the second image sensor is arranged in the line.

19. The time-of-flight module according to claim 18, wherein the first image sensor is on a first side of the time-of-flight sensor and the second image sensor is on a second side of the time-of-flight sensor, wherein a distance between the switchable illuminator and the first image sensor and a distance between the switchable illuminator and the second image sensor are substantially equal.

20. The time-of-flight module according to claim 16, further comprising:
a first image sensor configured to generate first image data representing a first image of the scene;
wherein the switchable illuminator is arranged adjacent to the time-of-flight sensor in a first direction and the first image sensor is arranged adjacent to the time-of-flight sensor in a second direction orthogonal to the first direction.
